(19) United States
(12) Patent Application Publication
(10) Pub. No.: US 2024/0174449 A1
(43) Pub. Date: May 30, 2024

(54) CONVEYOR SYSTEM FOR CONVEYING GOODS TO BE CONVEYED

(71) Applicants: Jürgen BIALY, Oeschebüttel (DE); PROVISUR TECHNOLOGIES, INC., Chicago, IL (US)

(72) Inventors: Jürgen BIALY, Oeschebüttel (DE); Klaus GUGGEMOS, Rettenberg (DE); Paul GOROLL, Waltenhofen (DE); Matthias HINDORFF, Waltenhofen (DE); Alexander MAY, Waltenhofen (DE); Florian MOHR, Sulzberg (DE); Klaus Dieter SCHROFF, Konstanz (DE)

(21) Appl. No.: 18/548,210

(22) PCT Filed: Feb. 17, 2022
(86) PCT No.: PCT/EP2022/053951

§ 371 Date: Aug. 28, 2023

(30) Foreign Application Priority Data
Mar. 3, 2021 (DE) 10 2021 105 101.0

(51) Int. Cl. B65G 17/48; B65G 47/74; B65G 54/02

(52) U.S. Cl. CPC B65G 17/48; B65G 47/74; B65G 54/02; B65G 2201/0202

(57) ABSTRACT

The invention relates to a conveyor system for conveying products (18) to be conveyed, in particular for conveying food products, with at least one conveyed-products carrier (4) for receiving the products (18) to be conveyed, and a drive system (17) for discontinuously conveying the conveyed-products carrier (4) within a conveying surface (9) along a conveying path. The invention provides that the drive system (17) angles the conveyed-products carrier (4) to the conveying surface (9).

The invention relates to a conveyor system for conveying goods to be conveyed, in particular for conveying food products (e.g. stacks or shingles with several slices of cheese, sausage or salami).

In the prior art, food processing installations are known which slice food products (e.g. pieces of meat, pieces of cheese or sticks of salami) into slices by means of a slicing device, which are then deposited on a conveyor belt and transported away.

Furthermore, it is known from the state of the art to use a discontinuous conveyor instead of a conveyor belt (continuous conveyor) for conveying away the stacks of slices, which has several conveyed-products carriers (“movers”, “shuttles”) that can receive the stacks of slices and are then moved along a conveying path in the loaded state. In this case, acceleration forces or braking forces act on the stacks of slices on the conveyed-products carrier, which in extreme cases can cause the food products to slip off the conveyed-products carrier. In addition, it is difficult to remove the food products from the individual carriers.

With regard to the technical background of the invention, reference should also be made to DE 10 2019 101 290 B3, U.S. Pat. No. 2,012,004 27 58 A1, DE 10 2015 109 633 A1 and DE 10 2014 106 400 A1.

The invention is therefore based on the task of creating a correspondingly improved conveyor system.

This task is solved by a conveying system according to the invention in accordance with the main claim.

The conveyor system according to the invention is generally suitable for conveying products to be conveyed. Preferably, however, the conveyor system according to the invention is used for conveying food products, such as stacks or shingles consisting of several slices of cheese or meat. It should be noted, however, that a portion can also consist of only a single slice.

Furthermore, it should be mentioned that the conveyor system according to the invention comprises, in accordance with the prior art described at the beginning, at least one conveyed-products carrier, which is also referred to as a “mover” or “shuttle” in accordance with the usual technical terminology, and which serves to receive the food products. For example, stacks of slices comprising a plurality of slices of cheese or sausage can each be deposited on such a conveyed-products carrier.

Furthermore, in accordance with the prior art described at the outset, the conveyor system according to the invention also comprises a drive system for conveying the conveyed-products carrier discontinuously within a conveying surface along a conveying path.

Such conveyor systems consisting of a drive system and at least one conveyed-products carrier can have a fixed conveying path which cannot be changed without mechanical adaptation, so that the individual conveyed-products carriers are moved in a virtually rail-bound manner.

In a preferred embodiment of the invention, however, a conveying system (drive system and con-veyed-products carrier) is used in which the conveying path can be freely programmed within a conveying surface without mechanical adjustments. Such a conveyor system is marketed by the German company Beckhoff Automation GmbH under the product name “XPlanar”.

In the known discontinuous conveyor systems, the conveyed-products carrier is always aligned parallel to the conveying surface. As a result, the acceleration forces or braking forces occurring during operation act parallel to the receiving surface of the conveyed-products carrier and, in extreme cases, can cause the food products to slide off the conveyed-products carrier. The conveyor system according to the invention is now distinguished from the prior art in that the drive system can angle the conveyed-products carrier to the conveying surface in order to prevent the conveyed product from slipping off the receiving surface of the conveyed-products carrier, as will be described in detail.

In the preferred embodiment of the invention, the conveying surface is oriented substantially horizontally, in particular with an angular deviation from the horizontal of less than 100, 5° or 2°. Alternatively, however, it is possible that the conveying surface is oriented substantially vertically, in particular with an angular deviation from the vertical of less than 100, 5° or 2°. Furthermore, there is the alternative possibility that the conveying surface is oriented obliquely.

Furthermore, the conveyor system according to the invention preferably comprises a transfer conveyor which serves to deposit the food products on the conveyed-products carrier or to remove them from the conveyed-products carrier. Such transfer conveyors are known per se from the prior art and are described, for example, in the German patent application DE 10 2020 105 678.8, so that the contents of this earlier patent application are to be fully attributed to the present description with respect to the structure and operation of the transfer conveyor. In the preferred embodiment of the invention, the transfer conveyor is a continuous conveyor, such as a conveyor belt.

For transferring the food products from or to the conveyed-products carrier, the transfer conveyor is preferably arranged above the horizontal conveying surface and is vertically pivotable.

Thus, for a product transfer, the transfer conveyor is preferably swiveled down onto the conveyed-products carrier located below, so that a food product can be removed from the conveyed-products carrier or deposited on the conveyed-products carrier.

Otherwise, the transfer conveyor is preferably swiveled into a raised passing position in which the conveyed-products carrier can pass the transfer conveyor. This is useful so that the transfer conveyor in the passing position does not impede the free movement of the conveyed-products carriers in the conveying surface.

In general, it should be mentioned that the transfer conveyor preferably comprises a plurality of parallel narrow conveyor belts, which may also be referred to as knife conveyors or finger conveyors, and which are capable of diving into corresponding elongated parallel recesses in the receiving surface of the conveyed-products carrier in order to engage underneath and convey away the food product deposited on the conveyed-products carrier, as described in the German patent application DE 10 2020 105 678.8 already mentioned above.

Furthermore, it should be mentioned that the conveyor system according to the invention preferably comprises a control device which controls the drive system and can set one of the following movement states.

On the one hand, the control device can control a conveyed-products carrier to assume a loading state in which the conveyed-products carrier is stationary or moves at only a low conveying speed to enable loading of the conveyed-products carrier with one of the food products. In the loading state, the conveyed-products carrier is positioned below the associated transfer conveyor so that the transfer conveyor can deposit the conveyed product on the conveyed-products carrier.

On the other hand, the control device can control a conveyed-products carrier to assume an unloading state in which the conveyed-products carrier is also stationary or moves only at a low conveying speed to allow the conveyed-products carrier to be unloaded. In the unloading state, the conveyed-products carrier is positioned below the associated transfer conveyor to allow the transfer conveyor to remove the conveyed-products from the conveyed-products carrier.

Further, the control device may control the conveyed-products carrier to assume an acceleration state in which it is accelerated within the conveying surface along the conveying path.

Finally, the control device can also control a conveyed-products carrier to assume a braking state in which the conveyed-products carrier is braked along the conveying path.

However, the control device preferably controls not only the drive system, but also the transfer conveyor. Thus, the control device controls the transfer conveyor in the loading state and in the unloading state such that the transfer conveyor is lowered to allow a food product to be deposited or removed from the conveyed-products carrier. Otherwise, the control device controls the transfer conveyor, on the other hand, so that it is raised to a passing position so as not to impede the free movement of the conveyed-products carriers within the conveying surface. The angle adjustment of the loading and unloading conveyor can optionally also be set manually.

Furthermore, in the loading state and in the unloading state, the control device also controls the conveyed-products carrier to be angled with respect to the conveying surface to facilitate product deposition or removal from the conveyed-products carrier. In the loading state, the conveyed-products carrier is preferably tilted forward in the conveying direction. In the unloading state, on the other hand, the conveyed-products carrier is preferably tilted backwards against the conveying direction.

It has already been briefly mentioned above that the angling of the conveyed-products carrier relative to the conveying surface is intended to prevent the food products from sliding off the con-veyed-products carrier due to the inertial forces acting during operation. In the acceleration state, the conveyed-products carrier is therefore preferably tilted forward in the direction of movement of the conveyed-products carrier. In the braking state, on the other hand, the conveyed-products carrier is preferably tilted backwards against the direction of movement of the conveyed-products carrier. In this way, the food products can be prevented from slipping off the conveyed-products carrier, and this is largely independent of the braking forces or acceleration forces that occur.

In the preferred embodiment, the tilt angle of the conveyed-products carrier is adapted to the inertial forces that occur in such a way that the resultant of the inertial force on the one hand and the gravitational force on the other is always aligned at right angles to the contact surface of the conveyed-products carrier. This prevents the food products placed on the carrier from sliding off the carrier, regardless of the acceleration of the carrier.

It has already been briefly mentioned above that the magnetic levitation system can be used as the drive system, which is available under the product name “XPlanar” from the German company Beckhoff Automation GmbH. It is to be mentioned that the drive system preferably works contact-less without a contact between the conveying surface on the one hand and the conveyed-products carrier on the other hand. Furthermore, it is to be mentioned that the drive system is preferably a magnetic levitation system, so that the conveyed-products carrier floats at a distance above the conveying surface.

Furthermore, it is to be mentioned that the drive system preferably comprises several modules which are adjacent to each other and together form the conveying surface. The modules of the drive system are therefore preferably rectangular in each case, so that the modules can be assembled without gaps to form the conveying surface. Alternatively, however, it is also possible for there to be a small distance between each of the individual modules of the drive system. Furthermore, it should be mentioned that the conveying path is preferably freely programmable within the conveying surface without mechanical adjustments, so that the conveyed-products carrier is not bound to a fixed predetermined conveying path.

With regard to the construction and the mode of operation of the individual conveyed-products carriers, reference can be made to the German patent application DE 10 2020 105 678.8 already briefly mentioned above, so that the contents of this earlier patent application can be fully attributed to the present description with regard to the construction and the mode of operation of the conveyed-products carriers. At this point, it should only be briefly mentioned that the conveyed-products carrier can have several parallel and elongated recesses on its upper side, into which—as already briefly mentioned above—the individual knife conveyors or finger conveyors of the transfer conveyor can dive in order to reach under and convey away the food product lying on the conveyed-products carrier. The recesses in the conveyed-products carrier are preferably wider than the individual conveyor belts (finger conveyors or knife conveyors) of the transfer conveyor, so that the individual conveyor belts of the transfer conveyor can dive into the elongated recesses in the con-veyed-products carrier. The gap between the immediately adjacent conveyor belts of the transfer conveyor is therefore preferably larger than the distance between the immediately adjacent recesses in the conveyed-products carrier.

For example, the conveyed-products carrier can have a plurality of pins on its upper side, which are arranged in a matrix in pin rows and pin columns, whereby the immediately adjacent pin rows and also the immediately adjacent pin columns each enclose one of the above-mentioned recesses, into which the finger conveyors or knife conveyors of the transfer conveyor can dive.

Furthermore, it should be mentioned that the invention does not only claim protection for the above-described conveyor system according to the invention. Rather, the invention also claims protection for a corresponding operating method, the individual process steps of the operating method already resulting from the present description, so that a separate description of the individual steps of the operating method can be dispensed with.

Other advantageous further embodiments of the invention are indicated in the dependent claims or are explained in more detail below together with the description of the preferred embodiment example of the invention with reference to the figures.

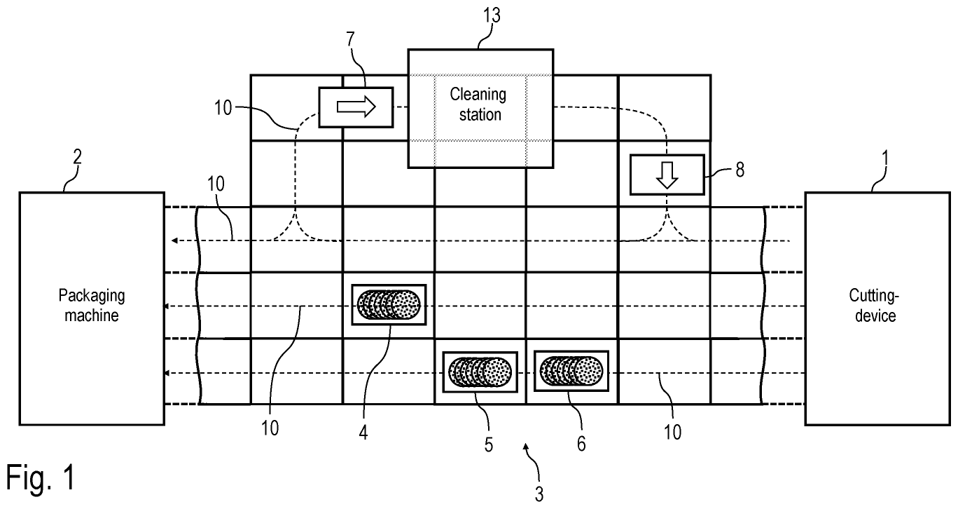

FIG. 1 shows a schematic representation of a food processing installation according to the invention with a conveyor system according to the invention.

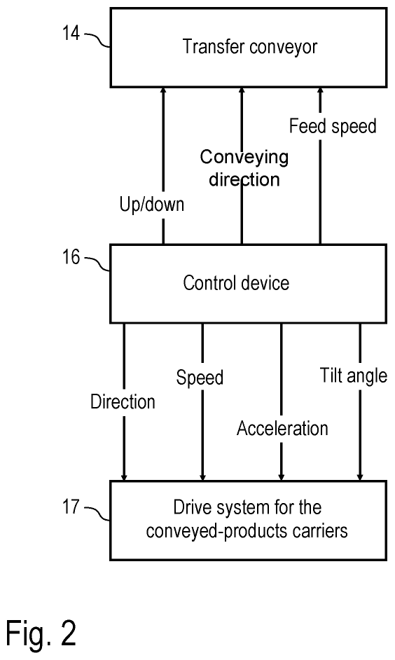

FIG. 2 shows a highly simplified representation of the control device of the conveyor system according to the invention.

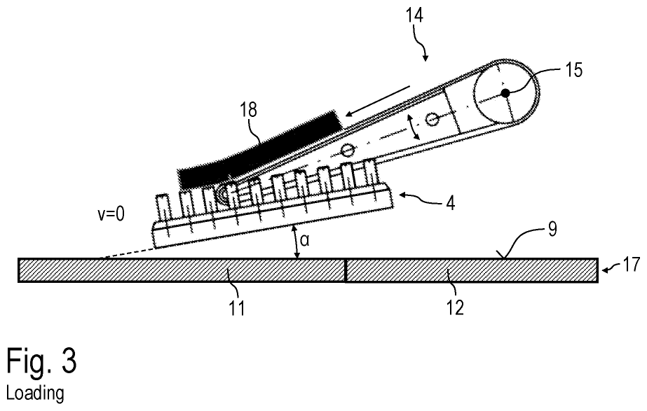

FIG. 3 shows a side view of a conveyed-products carrier with a transfer conveyor when loading the conveyed-products carrier with a food product.

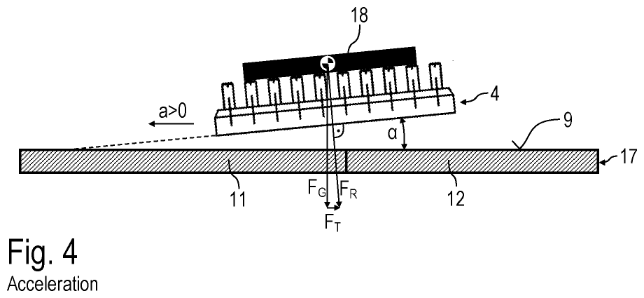

FIG. 4 shows the loaded conveyed-products carrier accelerating along the conveying path.

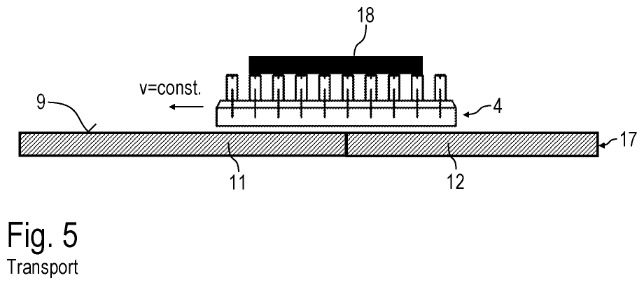

FIG. 5 shows the loaded conveyed-products carrier moving along the conveying path at a constant speed.

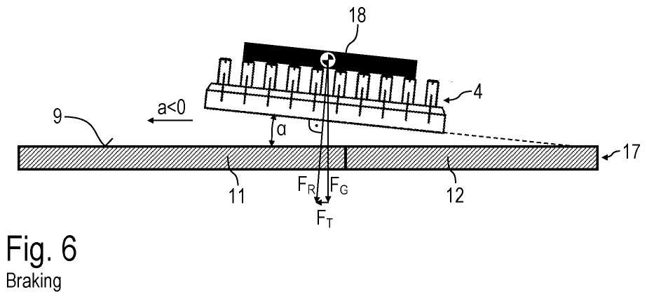

FIG. 6 shows the loaded conveyed-products carrier during braking.

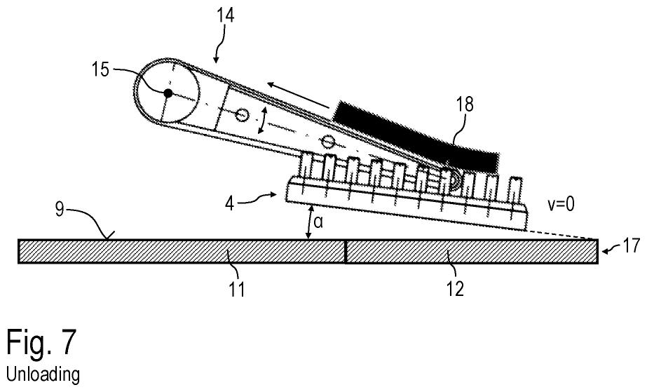

FIG. 7 shows the conveyed-products carrier being unloaded by a transfer conveyor.

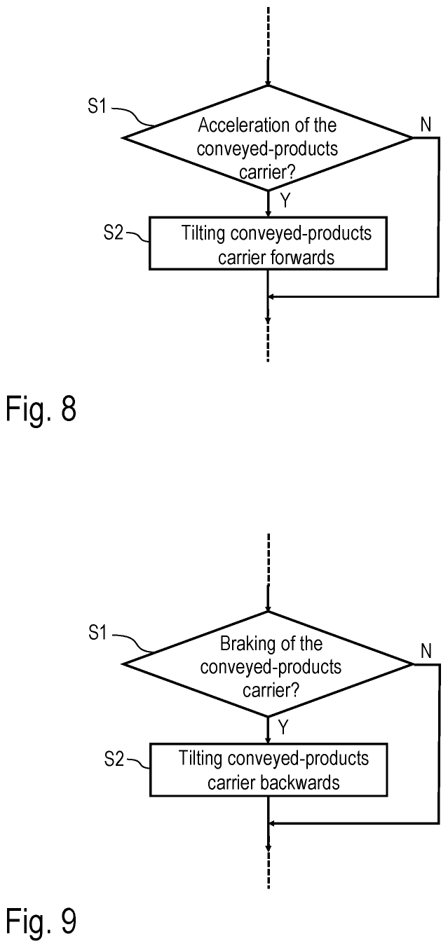

FIGS. 8-11 show various operating phases, each in the form of a flow diagram.

In the following, a schematic representation of a food processing installation according to the invention as shown in FIG. 1 is described. First of all, the food processing installation comprises a cutting device 1 which can cut food products (e.g. pieces of meat, pieces of cheese, salami sticks) into slices. Such cutting devices 1 are known per se from the prior art and are also referred to as “slicers”.

In addition, the food processing installation according to the invention comprises a packaging machine 2, which may be, for example, a so-called thermoformer, which packs the stacks of slices produced by the cutting device 1 into transparent packages. Such packaging machines 2 are in themselves known from the prior art and therefore need not be described in detail.

For transporting the food products from the cutting device 1 to the packaging machine 2, the food processing installation according to the invention comprises a conveyor system 3 which can move a plurality of conveyed-products carriers 4-8 within a horizontal conveying surface 9 along a conveying path 10, the conveying path 10 of the individual conveyed-products carriers 4-8 being freely programmable and being individually definable for the individual conveyed-products carriers 4-8. For example, the conveyor system 3 may be a conveyor system available from the German company Beckhoff Automation GmbH under the product name “XPlanar”. This is a magnetic levitation system, so that the individual conveyed-products carriers 4-8 float without contact above the conveying surface 9. Furthermore, it should be mentioned that the conveying surface 9 is composed of several rectangular modules 11, 12, so that almost any design of the conveying surface 9 can be realized.

Furthermore, the food processing installation according to the invention comprises a cleaning station 13 in which the unloaded conveyed-products carriers 7, 8 can be cleaned. Thus, the drawing shows the conveyed-products carrier 7 in the unloaded state during travel into the cleaning station 13, while the conveyed-products carrier 8 has already completed a cleaning process and has been moved out of the cleaning station 13 again.

Furthermore, the food processing installation according to the invention comprises a transfer conveyor 14 on the side of the cutting device 1 and on the side of the packaging machine 2, respectively, which is shown in FIGS. 3-7 in various operating phases.

From the German patent application DE 10 2020 105 678.8, both the transfer conveyor 14 and the individual conveyed-products carriers 4-8 are fundamentally known, both in terms of their structure and their mode of operation. At this point, it is therefore only necessary to briefly mention that the transfer conveyor 14 can be pivoted in the vertical direction about a swivel axis 15, as will be described in detail.

In addition, the food processing device according to the invention has a control device 16 which controls the transfer conveyor 14 and determines whether the transfer conveyor 14 is pivoted upwards or downwards, as will be described in detail, although this is only optional.

Furthermore, the control device 16 also controls a drive system 17 that consists of the modules 11, 12. Here, the control unit 16 specifies the desired direction, speed, acceleration and tilt angle for the individual conveyed-products carriers 4-8.

In the following, a loading state is described as shown in FIG. 3. Here, a food product 18 is located on the transfer conveyor 14 on the side of the cutting device 1, which is to be deposited on the conveyed-products carrier 4. For this purpose, the conveyed-products carrier 4 is positioned below the transfer conveyor 14 by the drive system 17. In doing so, the conveyed-products carrier 4 is angled at a certain tilt angle α relative to the conveying surface 9 to facilitate the loading process.

Subsequently, the transfer conveyor 14 is swivelled down so that the individual knife conveyors of the transfer conveyor 14 can dive into the recesses between the pins arranged in a matrix on the upper side of the conveyed-products carrier 4. Subsequently, the transfer conveyor 14 then de-posits the food product 16 on the pins of the conveyed-products carrier 4. Angling the conveyed-products carrier 4 relative to the conveying surface 9 facilitates the loading process here.

The acceleration state shown in FIG. 4 is now described below. Here, the conveyed-products carrier 4 loaded with the food product 18 is accelerated along the conveying path 10 with an acceleration a. The food product 18 is then conveyed along the conveying path 10. This results in an inertial force F_{T} acting on the food product 18 in addition to the gravitational force F_{G}. The conveyed-products carrier 4 is now tilted forward in the conveying direction at a tilt angle α such that the resultant F_{R} of the gravitational force F_{G} and the inertial force F_{T} is aligned at right angles to the receiving surface of the conveyed-products carrier 4. Thus, independent of the acceleration a, the food product 18 is prevented from sliding off the conveyed-products carrier 4.

In the following, the transport state shown in FIG. 5 will be described. In this transport state, the conveyed-products carrier 4 loaded with the food product 18 moves along the conveying path 10 at a constant speed v=const. In this transport state, therefore, no inertial forces act on the food product 18 either. The conveyed-products carrier 4 is therefore aligned parallel to the conveying surface 9 in the transport state.

In the following, the braking state is described, which is shown in FIG. 6. In the braking state, the conveyed-products carrier 4 loaded with the food product 18 is braked along the conveying path 10 with a negative acceleration a<0. This means that, in addition to the gravitational force F_{G}, the inertial force F_{T} again acts on the food product 18. The conveyed-products carrier 4 is therefore tilted backwards against the conveying direction in such a way that the resulting F_{R} from the gravitational force F_{G} and the inertial force F_{T} is aligned at right angles to the receiving surface of the conveyed-products carrier 4. In this way, regardless of the braking acceleration a, it is achieved that the food product 18 does not slide off the conveyed-products carrier 4.

In the following, the unloading state will now be described, which is shown in FIG. 7 and serves to remove the food product 18 from the conveyed-products carrier 4. For this purpose, the transfer conveyor 14 is again provided, which is arranged above the conveying surface 9.

In order to avoid misunderstandings, it should be mentioned that the transfer conveyor 14 is provided several times, namely, on the one hand, behind the cutting device 1 for depositing product on the conveyed-products carriers 4-8 and, on the other hand, in front of the packaging machine 2 for removing product from the conveyed-products carriers 4-8. However, the transfer conveyor 14 can be of the same design in both cases and is therefore described only once in identical construction.

In the unloading position according to FIG. 7, the conveyed-products carrier 4 is positioned below the transfer conveyor 14. The conveyed-products carrier 4 is angled at a tilt angle α to facilitate the unloading process. The transfer conveyor 14 is then swung down so that the knife conveyors or finger conveyors of the transfer conveyor 14 can dive into the recesses between the upwardly pro-jecting pins on the conveyor support 4 in order to discharge the food product 18. The angling of the conveyed-products carrier 4 during unloading facilitates the unloading process in this case.

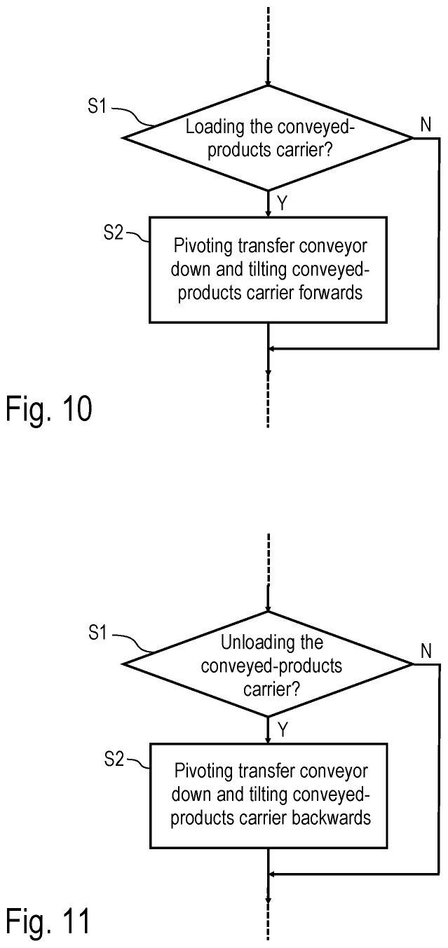

The flow diagrams in FIGS. 8-11 illustrate the tilting process during acceleration of the conveyed-products carrier 4 (FIG. 8), during deceleration of the conveyed-products carrier 4 (FIG. 9), during loading of the conveyed-products carrier 4 (FIG. 10) and during unloading of the conveyed-products carrier 4 (FIG. 11).

The invention is not limited to the preferred embodiment described above. Rather, a large number of variants and modifications are possible which also make use of the inventive idea and therefore fall within the scope of protection. In particular, the invention also claims protection for the subject-matter and the features of the dependent claims independently of the respective claims referred to and in particular also without the features of the main claim. The invention thus comprises various aspects of invention which enjoy protection independently of one another.

### LIST OF REFERENCE SIGNS

1 Cutting device
2 Packaging machine
3 Conveyor system
4-8 Conveyed-products carriers
9 Conveying surface
10 Conveying path
11, 12 Drive system modules
13 Cleaning station
14 Transfer conveyor
15 Swivel axis of the transfer conveyor
16 Control device
17 Drive system for the transfer conveyor
18 Food product
a Acceleration of the conveyed-products carrier
v Velocity of the conveyed-products carrier
α Tilt angle of the conveyed-products carrier
F_{G} Gravitational force acting on the food product
F_{T} Inertia force acting on the food product
F_{R} Resultant of inertia force and gravitational force

1. A conveyor system for conveying products to be conveyed, in particular for conveying food products, comprising:
at least one conveyed products carrier for receiving the products to be conveyed; and
a drive system for discontinuously conveying of the conveyed products carrier within a conveying surface along a conveying path, wherein
the drive system angles the conveyed products carrier to the conveying surface

2. The conveyor system according claim 1,
wherein the conveying surface is oriented essentially horizontally, in particular with an angular deviation from the horizontal of less than 10°, 5° or 2°, or
wherein the conveying surface is oriented essentially vertically, in particular with an angular deviation from the vertical of less than 10°, 5° or 2°, or
wherein the conveying surface is oriented obliquely.

3. The conveyor system according to claim 1,
wherein the conveyor system for depositing the products to be conveyed on the conveyed products carrier and/or for removing the products to be conveyed from the conveyed products carrier,
wherein the transfer conveyor is optionally a continuous conveyor,
wherein the transfer conveyor is optionally arranged above the horizontal conveying surface and is vertically pivotable between a lowered transfer position for transferring the products to be conveyed and a raised passing position in which the conveyed products carrier can pass the transfer conveyor, and
wherein the transfer conveyor optionally comprises several parallel conveyor belts.

4. The conveyor system according to claim 1, wherein the conveyor system comprises a control device which controls the drive system so that the conveyed products carrier assumes one of the following movement states:
a) a loading state with a standstill or optionally a low conveying speed of the con-veyed products carrier for loading the conveyed products carrier with the products to be conveyed,
b) an unloading state with a standstill or optionally a low conveying speed of the conveyed products carrier for a discharge of the conveyed products carrier from the products to be conveyed with which the conveyed products carrier is loaded,
c) an acceleration state in which the conveyed products carrier is accelerated in the horizontal direction along the conveying path, and
d) a braking state in which the conveyed products carrier is braked in the horizontal direction along the conveying path.

5. The conveyor system according to claim 4, wherein the control device also controls the transfer conveyor such,
wherein in the loading state, the transfer conveyor is lowered into the transfer position,
wherein in the unloading state, the transfer conveyor is lowered into the transfer position, and
wherein outside the loading state and optionally the unloading state, the transfer conveyor is raised into the passing position.

6. The conveyor system according to claim 4,
wherein in the acceleration state, the drive system tilts the conveyed products carrier forward in the direction of movement of the conveyed products carrier, and/or
wherein in the braking state, the drive system tilts the conveyed products carrier backward against the direction of movement of the conveyed products carrier, and/or
wherein in the loading state, the drive system tilts the conveyed products carrier forward in the conveying direction of the transfer conveyor, and/or
wherein in the unloading state, the drive system tilts the conveyed products carrier backwards opposite to the conveying direction of the transfer conveyor.

7. The conveyor system according to claim 1,
wherein the drive system operates contactlessly without any contact between the conveying surface and the conveyed products carrier,
wherein the drive system is optionally a magnetic levitation system, so that the conveyed products carrier floats at a distance above the conveying surface,
wherein the drive system optionally comprises a plurality of modules which are adjacent to one another and together form the conveying surface,
wherein the individual modules of the drive system are optionally rectangular in each case, so that the modules can optionally be assembled without gaps to form the conveying surface, and
wherein the conveying path is optionally freely programmable within the conveying surface, so that the conveyed products carrier is not bound to a fixed conveying path.

8. The conveyor system according to claim 1,
wherein the conveyed products carrier comprises, on its upper side, a plurality of parallel and elongated recesses for the introduction of the individual conveyor belts of the transfer conveyor during a transfer of the conveyed product from the conveyed products carrier or onto the conveyed products carrier,
wherein the recesses in the conveyed products carrier are optionally wider than the individual conveyor belts of the transfer conveyor, so that the individual conveyor belts of the transfer conveyor can be introduced into the individual recesses in the conveyed products carrier, and
wherein the gap between the immediately adjacent conveyor belts of the transfer conveyor is optionally greater than the distance between the immediately adjacent recesses in the conveyed products carrier.

9. The conveyor system according to claim 8,
wherein the conveyed products carrier comprises, on its upper side, a plurality of pins which project upwards from the conveyed products carrier and enclose the recesses between them,
wherein the pins are optionally arranged in matrix form in pin rows and pin columns,
wherein the pin rows and the pin gaps are optionally arranged at right angles to one another,
wherein the immediately adjacent pin rows optionally each enclose paired recesses between them,
wherein the immediately adjacent pin columns optionally each enclose the recesses between them in pairs,
wherein the pins optionally all have the same length, and/or
wherein the pins optionally project upwardly at right angles from the loading surface, and/or
wherein the pins are optionally all aligned parallel to each other, and/or
wherein the pins optionally each have a round or angular cross section.

10. A method for operating a conveyor system comprising:
loading the conveyed products carrier with the products to be conveyed, in particular by means of the transfer conveyor;
transporting the conveyed products carrier with the products to be conveyed within the conveying surface along the conveying path by means of the drive system; and
unloading the products to be conveyed from the conveyed products carrier, in particular by means of the transfer conveyor,
wherein the conveyed products carrier is angled to the conveying surface by means of the drive system.

11. A method according to claim 10,
wherein the conveyed products carrier with the loaded products to be conveyed is accelerated along the conveying path by the drive system,
wherein the conveyed products carrier is tilted forward in the conveying direction by the drive system during the acceleration, and
wherein the conveyed products carrier is optionally tilted during acceleration in such a way that the resultant of the inertial force acting on the products to be conveyed and the gravitational force acting on the products to be conveyed is aligned at right angles to the receiving surface of the conveyed products carrier.

12. A method according to claim 10,
wherein the conveyed products carrier with the loaded products to be conveyed is braked along the conveying path by the drive system,
wherein the conveyed products carrier is tilted backwards by the drive system against the conveying direction during the acceleration, and
wherein the conveyed products carrier is optionally tilted during braking in such a way that the resultant of the inertial force acting on the products to be conveyed and the gravitational force acting on the products to be conveyed is aligned at right angles to the receiving surface of the conveyed products carrier.

13. A method according to claim 10, wherein the conveyed products carrier is tilted forwards in the conveying direction of the transfer conveyor by the drive system when the products to be conveyed are loaded by the transfer conveyor.

14. A method according to claim 10, wherein the conveyed products carrier is tilted backwards by the drive system against the conveying direction of the transfer conveyor when the products to be conveyed are unloaded by the transfer conveyor.
